(19) United States
(12) Patent Application Publication
(10) Pub. No.: US 2026/0046771 A1
(43) Pub. Date: Feb. 12, 2026

(54) Methods And Apparatus For Radio Resource Management Relaxation And Offloading In Mobile Communications

(71) Applicant: MediaTek Inc., Hsinchu City (TW)

(72) Inventors: Ogeen Hanna Toma Toma, Cambridge (GB); Waseem Hazim Ozan Ozan, Cambridge (GB); Tsang-Wei Yu, Hsinchu City (TW)

(21) Appl. No.: 19/268,040

(22) Filed: Jul. 14, 2025

Related U.S. Application Data
(60) Provisional application No. 63/681,952, filed on Aug. 12, 2024.

(51) Int. Cl. H04W 52/02; H04W 24/08

(52) U.S. Cl. CPC H04W 52/0235; H04W 24/08; H04W 52/028

(57) ABSTRACT

Various solutions for Radio Resource Management (RRM) relaxation and offloading with respect to an apparatus in mobile communications are described. The apparatus may determine a network condition. The apparatus may determine a specific state of a plurality of states based on the network condition. The specific state may correspond to an RRM stage. The apparatus may control a Main Radio (MR) and a Low-power Receiver (LR) based on the RRM stage.

### CROSS REFERENCE TO RELATED PATENT APPLICATION(S)

The present disclosure is part of a non-provisional application claiming the priority benefits of U.S. Patent Application No. 63/681,952, filed on 12 Aug. 2024, the content of which herein being incorporated by reference in its entirety.

### TECHNICAL FIELD

The present disclosure is generally related to mobile communications and, more particularly, to Radio Resource Management (RRM) relaxation and offloading with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communication systems, techniques of Low Power Wake-Up Signal/Wake-Up Receiver (LP-WUS/WUR) are introduced for power saving. In particular, when a User Equipment (UE) supports LP-WUS/WUR, a Low-power Receiver (LR) of the UE may be used to monitor a wake-up signal, which may trigger a Main Radio (MR) of the UE to wake up. Therefore, power savings may be achieved by deactivating or relaxing the high-power-consuming MR while activating the LR to monitor the wake-up signal with ultra-low power consumption. For example, the LR of the UE may monitor an LP-WUS, which may be used to trigger activation of the MR of the UE for paging monitoring in an idle mode or an inactive mode, or for Physical Downlink Control Channel (PDCCH) monitoring in a connected mode. In another example, the LR of the UE may monitor a Low Power Synchronization Signal (LP-SS), or an existing Primary Synchronization Signal (PSS) and Secondary Synchronization Signal (SSS), for performing synchronization and Radio Resource Management (RRM) measurements of a serving cell in an idle or inactive mode.

However, UE behaviors related to RRM relaxation (i.e., reducing RRM activity while maintaining partial MR operation) and RRM offloading (i.e., transferring RRM functions from the MR to the LR entirely), which may be achieved by the MR of the UE when the LR is activated to monitor a wake-up signal, have not yet been defined. Accordingly, designing appropriate operational procedures for RRM relaxation and RRM offloading has become a critical issue in wireless communication systems, and there is an urgent need to provide such procedures to ensure efficient and reliable operation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to Radio Resource Management (RRM) relaxation and offloading with respect to apparatus in mobile communications.

In one aspect, a method may involve an apparatus determining a network condition. The method may also involve the apparatus determining a specific state of a plurality of states based on the network condition. The specific state may correspond to an RRM stage. The method may also involve the apparatus controlling a Main Radio (MR) and a Low-power Receiver (LR) based on the RRM stage.

In one aspect, an apparatus may comprise a transceiver which, during operation, wirelessly communicates with a network node. The apparatus may also comprise a processor communicatively coupled to the transceiver. The processor, during operation, may perform operations comprising determining a network condition. The processor may also perform operations comprising determining a specific state of a plurality of states based on the network condition. The specific state may correspond to an RRM stage. The processor may further perform operations controlling an MR and an LR based on the RRM stage.

In one aspect, a method may involve an apparatus transmitting a configuration of a plurality of states. The method may also involve the apparatus transmitting a signal for determining a network condition. The method may also involve the apparatus determining a specific state of the plurality of states based on the network condition. The specific state may correspond to an RRM stage. The method may also involve the apparatus communicating with a UE based on the RRM stage.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2 is a diagram depicting example scenarios under schemes in accordance with implementations of the present disclosure.

FIG. 3 is a diagram depicting example scenarios under schemes in accordance with implementations of the present disclosure.

FIGS. 4A to 4C are diagrams depicting example scenarios under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to Radio Resource Management (RRM) relaxation and offloading in mobile communications. According to the present disclosure, a number of possible solutions may be implemented separately or jointly. That is, although these possible solutions may be described below separately, two or more of these possible solutions may be implemented in one combination or another.

Regarding the present disclosure, the UE may determine a network condition. Then, the UE may determine a specific state of a plurality of states based on the network condition. The specific state may correspond to a Radio Resource Management (RRM) stage. The UE may control a Main Radio (MR) of the UE and a Low-power Receiver (LR) of the UE based on the RRM stage. The UE may communicate with a network node based on the RRM stage after controlling the MR and the LR. In some scenarios, the plurality of states may be preconfigured or predefined. In some scenarios, the network node may transmit a configuration of the plurality of states to the UE. Accordingly, based on varying network conditions, the UE may control the MR and the LR to operate in different RRM stages, thereby ensuring efficient and reliable operation of RRM relaxation and RRM offloading.

It should be noted that RRM may refer to a set of procedures performed by the UE and/or the network node to manage the allocation, monitoring, and optimization of radio resources in a wireless communication system. RRM may include, but is not limited to, signal quality measurements (e.g., Reference Signal Received Power (RSRP), Reference Signal Received Quality (RSRQ), Signal to Interference Noise Ratio (SINR), etc.), cell selection and reselection, handover decisions, mobility management, and control of uplink and downlink transmission parameters. RRM operations may be performed in various UE states, such as idle, inactive, or connected modes, and may be critical for maintaining communication reliability, spectral efficiency, and overall network performance under varying radio conditions. RRM stages may refer to different levels of RRM activity and operational behavior.

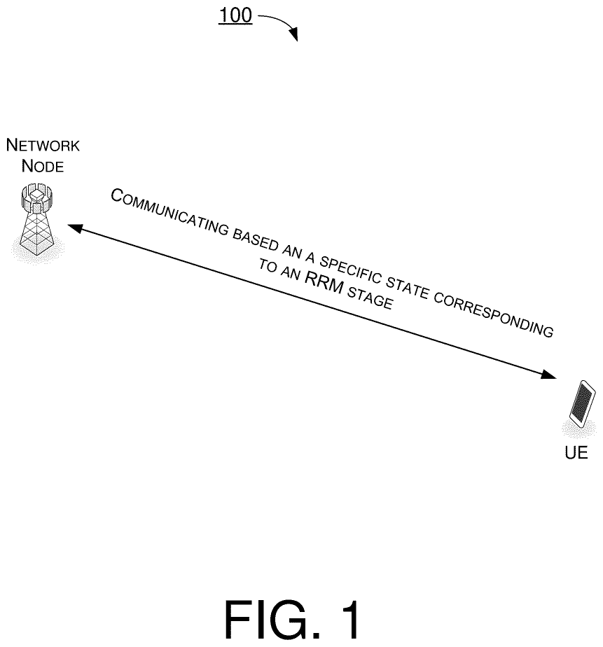

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more network nodes. For illustrative purposes, one network node and one UE may be described hereinafter. However, it is not intended to limit the network scenarios of the present disclosure.

In some embodiments, the UE may determine a network condition. The network condition may be determined based on a signal transmitted from the network node. In some cases, the network condition may be a measured signal quality (e.g., RSRP and/or RSRQ). In some cases, the network condition may be a reception of a Low Power-Wake Up Signal (LP-WUS).

Then, the UE may determine a specific state of a plurality of states based on the network condition. Each of the states may correspond to one RRM stage. The RRM stages may include a stage of normal RRM, at least one stage of RRM relaxation and a stage of offloading RRM to the LR. The stage of normal RRM may include legacy RRM. Each stage of RRM relaxation may correspond to a specific level of RRM activity reduction, with the MR remaining active in a limited or reduced-capability state. The stage of offloading RRM to the LR may represent a state in which RRM functions are entirely transferred from the MR to the LR.

Based on different RRM stages, the UE may correspondingly control the MR and the LR. In particular, with respect to the stage of normal RRM, the UE may enable the MR (i.e., the MR may be with ‘ON’ status) and deactivate the LR (i.e., the LR may be with ‘OFF’ status). With respect to the stage(s) of RRM relaxation, the UE may enable both the MR and activate the LR (i.e., both the MR and the LR may be with ‘ON’ status). With respect to the stage of offloading RRM to the LR, the UE may idle the MR (i.e., the MR may be with ‘OFF’ status) and activate the LR (i.e., the LR may be with ‘ON’ status).

Accordingly, after determining the specific state corresponding to a specific RRM state and controlling the MR and the LR based on the specific RRM state, the UE may communicate with the network node while operating in the corresponding MR and LR status. The UE may repeat the foregoing operations and determine whether a transit to another RRM stage is required based on updated network conditions. Therefore, based on changing network conditions, the UE may control the MR and the LR to operate in different RRM stages, thereby facilitating efficient and reliable management of RRM relaxation and RRM offloading.

In some cases, the plurality of states may be preconfigured or predefined between the network node and the UE. In some cases, the network node may transmit a configuration of the plurality of states to the UE.

In some implementations, the network condition may include a measured signal quality (e.g., RSRP and/or RSRQ) associated with the signal transmitted from the network node. The UE may determine a specific state of the plurality of states based on the network condition. In particular, the UE may determine the specific state based on whether the measured signal quality is greater than a threshold.

In some cases, when the UE determines that the measured signal quality is greater than the threshold, the UE may determine the specific state, and the specific state may correspond to the RRM stage including a stage of RRM relaxation or a stage of offloading RRM to the LR. Accordingly, the UE may: (1) enable the MR with the stage of RRM relaxation and activate the LR for LP-WUS monitoring when the RRM stage includes the stage of RRM relaxation, or (2) idle the MR with the stage of offloading RRM to the LR and activate the LR for LP-WUS monitoring when the RRM stage includes the stage of offloading RRM to the LR.

In some cases, when the UE determines that the measured signal quality is not greater than the threshold, the UE may determine the specific state, and the specific state may correspond to the RRM stage including a stage of normal RRM. Accordingly, the UE may enable the MR with the stage of normal RRM and deactivate the LR when the RRM stage includes the stage of normal RRM.

In addition, when the RRM stage includes the stage of RRM relaxation, the UE may start a timer. Then, the UE may determine another measured signal quality based on another signal after the timer expires. The UE may determine whether the another measured signal quality is greater than the threshold and then determine a specific state of the plurality of states based on the result.

In some cases, the network condition may include a reception of Low Power Wake Up signal (LP-WUS). In any stage, when the UE determines the reception of LP-WUS, the UE may determine the specific state, and the specific state may correspond to the RRM stage including a stage of normal RRM. Accordingly, the UE may enable the MR with the stage of normal RRM and deactivate the LR when the RRM stage includes the stage of normal RRM.

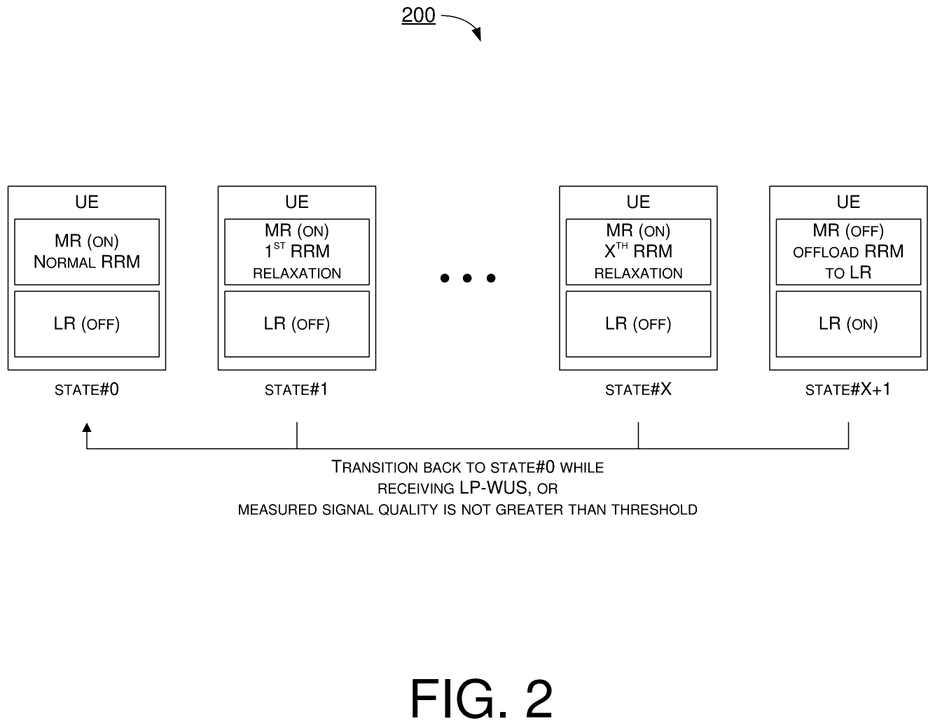

FIG. 2 illustrates an example scenario 200 under schemes in accordance with implementations of the present disclosure. In some implementations, there may be state #0 to state #X+1 while state #0 may correspond to stage of normal RRM, state #1 to state #X may correspond to stage of 1^{st} RRM relaxation to stage of X^{th} RRM relaxation stage, and state #X+1 may correspond to stage of offloading RRM to the LR.

In some cases, when the UE operates in the stage of normal RRM (i.e., the MR is ON and the LR is OFF), the UE may determine the network condition, including a measured signal quality, based on a signal transmitted from the network node. Then, the UE may determine a state #n of state #1 to state #X+1 based on the network condition. The UE may determine: (1) whether to activate the LR for LP-WUS monitoring and enable the MR with the stage of n^{th} RRM relaxation based on the network condition, or (2) whether to activate the LR for LP-WUS monitoring and idle the MR with the stage of offloading RRM to the LR based on the network condition.

In some cases, when the measured signal quality is greater than a threshold (i.e., signal transmission quality between the UE and the network node may be good enough so that the MR may reduce or suspend its RRM activity while maintaining connectivity through the LR), the UE may determine state #n. Then, the UE may control (1) the LR to be activated for LP-WUS monitoring and the MR to be enabled with the stage of n^{th} RRM relaxation while n is between 1 to X, or (2) the LR to be activated for LP-WUS monitoring and the MR to be enabled with the stage of offloading RRM to the LR while n is X+1.

In addition, transitioning to any stage of RRM relaxation may initiate a timer, which is used to determine a confidence level of the UE regarding whether to transit to a further stage of RRM relaxation or to a stage of offloading RRM to LR upon expiration of the timer.

In some cases, when the measured signal quality is not greater than the threshold (i.e., signal transmission quality between the UE and the network node is not good enough so that the MR may need to stay in normal RRM), the UE may determine state #0. Then, the UE may control the LR to be deactivated and the MR to be enabled with the stage of normal RRM. In some cases, when the UE receives an LP-WUS, the UE may determine state #0. Then, the UE may control the LR to be deactivated and the MR to be enabled with the stage of normal RRM.

More specifically, at any stage of RRM relaxation, the UE may remain in the same state unless the timer expires, or an event occurs that may trigger the UE to transition back to state #0. Such an event may include, for example, the LR receiving an LP-WUS to activate the MR, or the measured signal quality falling below the threshold. At the stage of offloading RRM to LR, the UE may remain in the same state unless an event occurs that may trigger the UE to transition back to state #0. Such an event may include, for example, the LR receiving an LP-WUS to activate the MR, or the measured signal quality falling below the threshold.

For example, there are a stage of normal RRM, two stages of RRM relaxation and a stage of offloading RRM to LR. First, the UE is in state #0 corresponding to the stage of normal RRM. When the UE determines state #1 based on that a measured signal quality is greater than a threshold, the MR of the UE enables 1^{st} stage of RRM relaxation (e.g., the RRM activity is reduced to a frequency between one-eighth and one-sixteenth of the normal operation), and the LR of the UE monitors LP-WUS in state #1. Then, the transit to state #1 activates timer #1.

When timer #1 expires at state #1, and no event (e.g., reception of LP-WUS or the measured signal quality falling below the threshold) triggers the UE to fallback to state #0, the MR of UE enables 2^{nd} stage of RRM relaxation (e.g., the RRM activity may be reduced to less than one-sixteenth of the normal frequency), and the LR of the UE monitors LP-WUS in state #2. Then, the transit to state #2 activates timer #2.

When timer #2 expires at state #2, and no event (e.g., reception of LP-WUS or the measured signal quality falling below the threshold) triggers the UE to fallback to state #0, the MR of UE is idled, and RRM is fully offloaded to LR at state #3.

In some implementations, the network condition may include a measured signal quality (e.g., RSRP and/or RSRQ) associated with the signal transmitted from the network node. The UE may determine a specific state of the plurality of states based on the network condition. In particular, the UE may determine the specific state based on: (1) whether the measured signal quality is greater than a threshold, and (2) whether a change associated with the measured signal quality is within a margin for a duration.

In some cases, when the UE determines that: (1) the measured signal quality is greater than the threshold, and (2) the change associated with the measured signal quality is within the margin for the duration, the UE may determine the specific state, and the specific state may correspond to the RRM stage including a stage of RRM relaxation or a stage of offloading RRM to the LR. Accordingly, the UE may: (1) enable the MR with the stage of RRM relaxation and activate the LR for LP-WUS monitoring when the RRM stage includes the stage of RRM relaxation, or (2) idle the MR with the stage of offloading RRM to the LR and activate the LR for LP-WUS monitoring when the RRM stage includes the stage of offloading RRM to the LR.

In some cases, when the UE determines that the change associated with the measured signal quality is over the margin for the duration, the UE may further determine whether the measured signal quality is greater than the threshold.

When the UE determines that the measured signal quality is greater than the threshold after determining the change associated with the measured signal quality is over the margin for the duration, the UE may determine the specific state, and the specific state may correspond to the RRM stage including a stage of RRM relaxation. Accordingly, the UE may enable the MR with the stage of RRM relaxation and activate the LR for LP-WUS monitoring when the RRM stage includes the stage of RRM relaxation.

When the UE determines that the measured signal quality is not greater than the threshold after determining the change associated with the measured signal quality is over the margin for the duration, the UE may determine the specific state, and the specific state may correspond to the RRM stage including a stage of normal RRM. Accordingly, the UE may enable the MR with the stage of normal RRM and deactivate the LR when the RRM stage includes the stage of normal RRM.

In some cases, the network condition may include a reception of Low Power Wake Up signal (LP-WUS). In any stage, when the UE determines the reception of LP-WUS, the UE may determine the specific state, and the specific state may correspond to the RRM stage including a stage of normal RRM. Accordingly, the UE may enable the MR with the stage of normal RRM and deactivate the LR when the RRM stage includes the stage of normal RRM.

In some cases, a reference value used to determine the change associated with the measured signal quality may include a baseline signal quality or a previously measured signal quality. In other words, the change may be calculated by comparing the currently measured signal quality against a fixed baseline or against a signal quality value obtained during a prior time period.

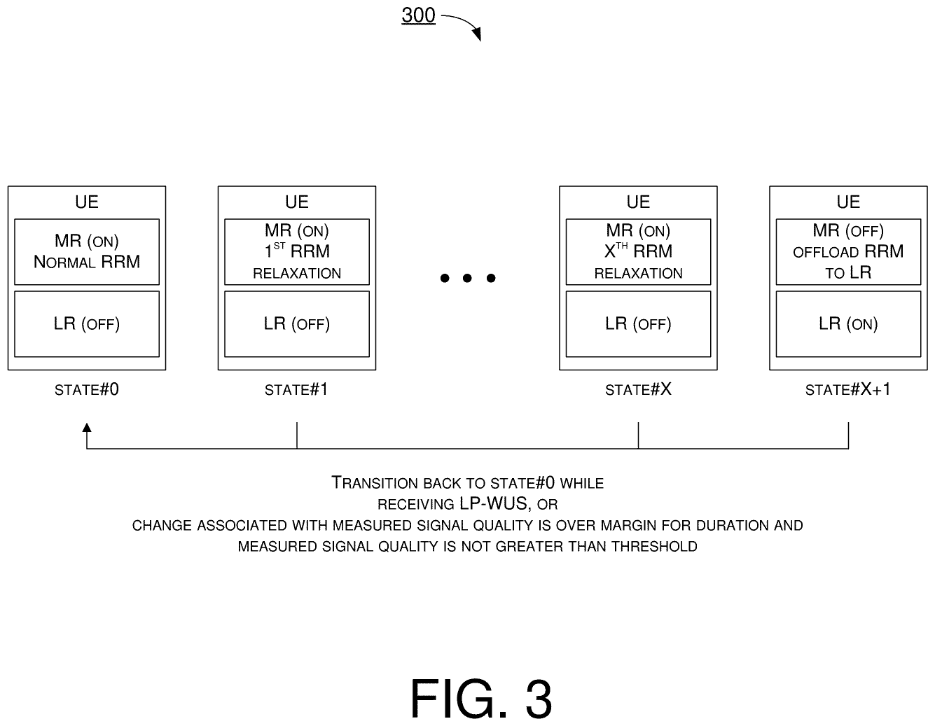

FIG. 3 illustrates an example scenario 300 under schemes in accordance with implementations of the present disclosure. In some implementations, there may be state #0 to state #X+1 while state #0 may correspond to stage of normal RRM, state #1 to state #X may correspond to stage of 1^{st} RRM relaxation to stage of X^{th} RRM relaxation stage, and state #X+1 may correspond to stage of offloading RRM to the LR.

In some cases, when the UE operates in the stage of normal RRM (i.e., the MR is ON and the LR is OFF), the UE may determine the network condition, including a measured signal quality and a change associated with the measured signal quality for a duration, based on a signal transmitted from the network node. Then, the UE may determine a state #n of state #1 to state #X+1 based on the network condition. The UE may determine: (1) whether to activate the LR for LP-WUS monitoring and enable the MR with the stage of n^{th} RRM relaxation based on the network condition, or (2) whether to activate the LR for LP-WUS monitoring and idle the MR with the stage of offloading RRM to the LR based on the network condition.

In some cases, when (1) the measured signal quality is greater than a threshold (i.e., signal transmission quality between the UE and the network node may be good enough so that the MR may reduce or suspend its RRM activity while maintaining connectivity through the LR), and (2) the change associated with the measured signal quality is within the margin for the duration (i.e., the variation in signal quality remains within a predefined threshold over a specified time period, indicating stable radio conditions), the UE may determine state #n. Then, the UE may control (1) the LR to be activated for LP-WUS monitoring and the MR to be enabled with the stage of n^{th} RRM relaxation while n is between 1 to X, or (2) the LR to be activated for LP-WUS monitoring and the MR to be enabled with the stage of offloading RRM to the LR while n is X+1.

In some cases, when the UE determines that the change associated with the measured signal quality is over the margin for the duration (i.e., the variation in signal quality exceeds a predefined threshold over a specified time period, indicating unstable or deteriorating radio conditions), the UE may determine whether the measured signal quality is not greater than the threshold.

After determining the change associated with the measured signal quality is over the margin for the duration, when the UE determines that the measured signal quality is still greater than the threshold (i.e., signal transmission quality between the UE and the network node may be good enough so that the MR may reduce or suspend its RRM activity while maintaining connectivity through the LR), the UE may remain in state #n. Then, the UE may control (1) the LR to be activated for LP-WUS monitoring and the MR to be enabled with the stage of n^{th} RRM relaxation while n is between 1 to X, or (2) the LR to be activated for LP-WUS monitoring and the MR to be enabled with the stage of offloading RRM to the LR while n is X+1.

After determining the change associated with the measured signal quality is over the margin for the duration, when the UE determines that the measured signal quality is not greater than the threshold (i.e., signal transmission quality between the UE and the network node may not be good enough so that the MR may need to stay in normal RRM), the UE determines state #0. Then, the UE may control the LR to be deactivated and the MR to be enabled with the stage of normal RRM. In some cases, when the UE receives an LP-WUS, the UE may determine state #0. Then, the UE may control the LR to be deactivated and the MR to be enabled with the stage of normal RRM.

More specifically, at n^{th} stage of RRM relaxation, if the change associated with the measured signal quality is within the margin for the duration, the UE may transit to (n+1)^{th} stage of RRM relaxation or (n+1)^{th} stage of offloading RRM to LR. At n^{th} stage of RRM relaxation, if the change associated with the measured signal quality is over the margin for the duration, the UE may remain at n^{th} stage of RRM relaxation while the measured signal quality remains above the threshold.

In some cases, an event may occur that causes the UE to transition back to state #0. Such an event may include, for example, the LR receiving an LP-WUS to activate the MR, or the measured signal quality falling below the threshold.

For example, there are a stage of normal RRM, two stages of RRM relaxation and a stage of offloading RRM to LR. First, the UE is in state #0 corresponding to the stage of normal RRM. When the UE determines state #1 based on that: (1) a measured signal quality is greater than a threshold, and (2) a change associated with the measured signal quality is within a margin for the duration, the MR of the UE enables 1^{st} stage of RRM relaxation (e.g., the RRM activity is reduced to a frequency between one-eighth and one-sixteenth of the normal operation), and the LR of the UE monitors LP-WUS in state #1.

When the UE determines state #2 based on that a change associated with the measured signal quality is still within a margin for the duration, the MR of UE enables 2^{nd} stage of RRM relaxation (e.g., the RRM activity may be reduced to less than one-sixteenth of the normal frequency), and the LR of the UE monitors LP-WUS in state #2.

When the UE determines state #3 based on that a change associated with the measured signal quality is still within a margin for the duration, the MR of UE is idled, and RRM is fully offloaded to LR at state #3.

In some implementations, the network condition may include a measured signal quality (e.g., RSRP and/or RSRQ) associated with the signal transmitted from the network node. The UE may determine a specific state of the plurality of states based on the network condition. In particular, the UE may determine the specific state in an event that the measured signal quality is greater than a threshold associated with the specific state.

In some cases, when the UE determines that the measured signal quality is greater than the threshold associated with the specific state, the UE may determine the specific state, and the specific state may correspond to the RRM stage including a stage of RRM relaxation or a stage of offloading RRM to the LR. Accordingly, the UE may: (1) enable the MR with the stage of RRM relaxation and activate the LR for LP-WUS monitoring when the RRM stage includes the stage of RRM relaxation, or (2) idle the MR with the stage of offloading RRM to the LR and activate the LR for LP-WUS monitoring when the RRM stage includes the stage of offloading RRM to the LR.

It should be noted that the threshold associated with the specific state may have a first value when the specific state corresponds to the RRM stage including the stage of RRM relaxation. The threshold associated with the specific state may have a second value in an event that the specific state corresponds to the RRM stage including the stage of offloading RRM to the LR. The second value may be greater than the first value.

In some cases, when the UE determines that the measured signal quality is not greater than the threshold associated with a higher state, the UE may determine the specific state, and the specific state may correspond to the RRM stage including a stage of RRM relaxation (while the specific state is not an initial state) or a stage of normal RRM (while the specific state is an initial stage). Accordingly, the UE may: (1) enable the MR with the stage of RRM relaxation and activate the LR for LP-WUS monitoring when the RRM stage includes the stage of RRM relaxation, or (2) enable the MR with the stage of normal RRM and deactivate the LR when the RRM stage includes the stage of normal RRM.

In some cases, the network condition may include a reception of Low Power Wake Up signal (LP-WUS). In any stage, when the UE determines the reception of LP-WUS, the UE may determine the specific state, and the specific state may correspond to the RRM stage including a stage of normal RRM. Accordingly, the UE may enable the MR with the stage of normal RRM and deactivate the LR when the RRM stage includes the stage of normal RRM.

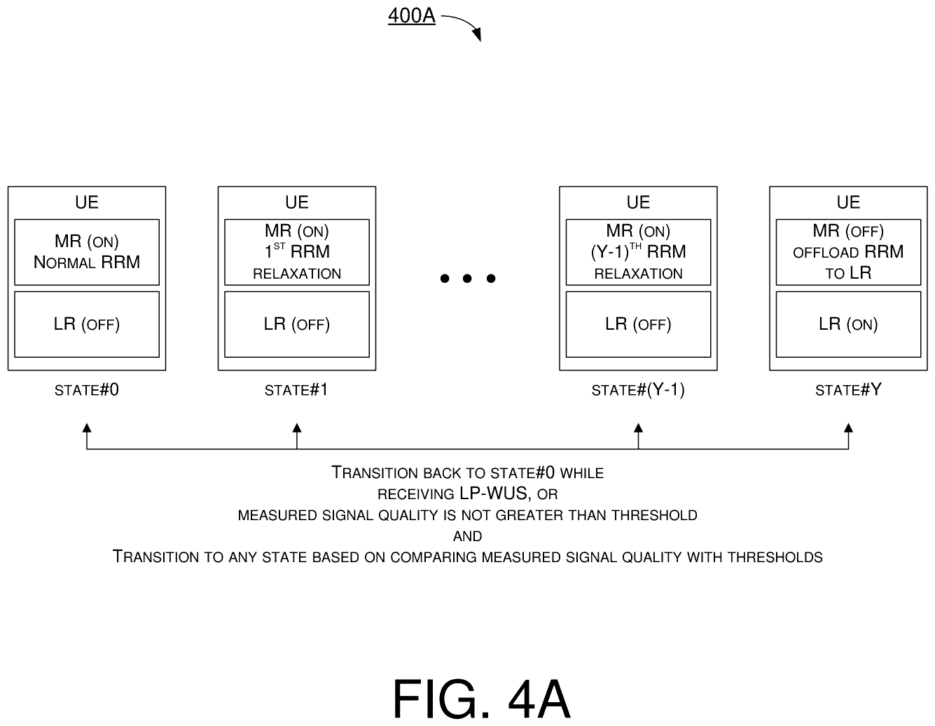

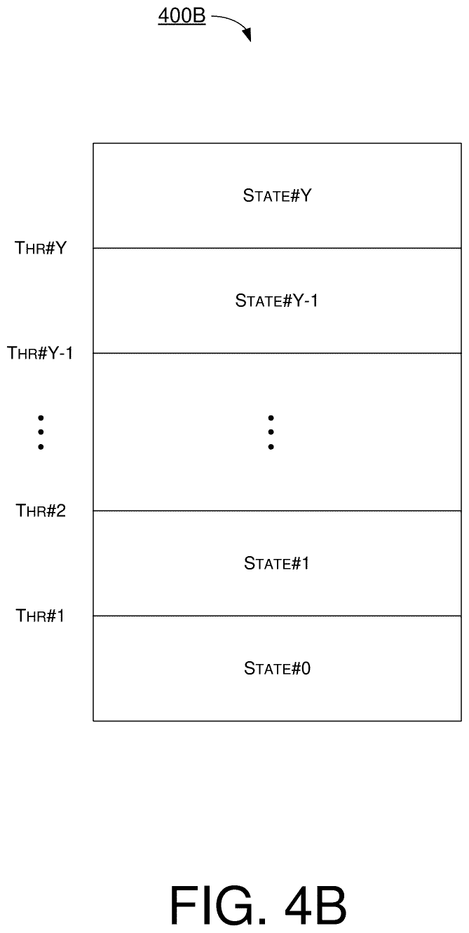

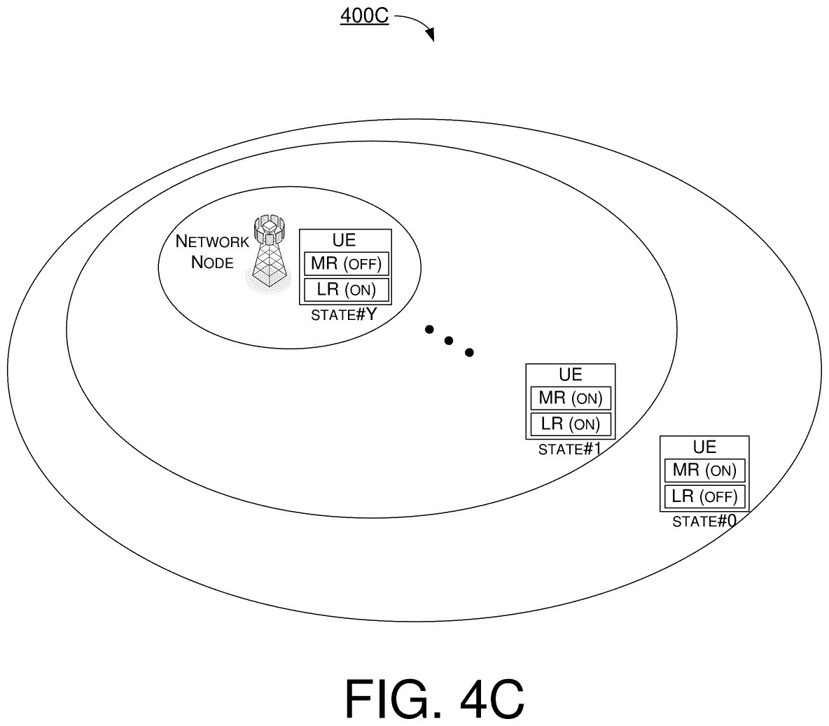

FIGS. 4A to 4C illustrate example scenarios 400A to 400C under schemes in accordance with implementations of the present disclosure. In some implementations, as shown in FIG. 4A, there may be state #0 to state #Y while state #0 may correspond to the stage of normal RRM, state #1 to state #(Y−1) may correspond to the stage of 1^{st} RRM relaxation to the stage of (Y−1)^{th} RRM relaxation stage, and state #Y may correspond to stage of offloading RRM to the LR. As shown in FIG. 4B, state #1 to state #Y may be associated with thresholds Thr #1 to Thr #Y. Thr #Y is higher than any of Thr #(Y−1) to Thr #1.

In some cases, the thresholds Thr #1 to Thr #Y may include RSRP values, and Thr #(a+1) is greater than Thr #a. In some cases, each of state #1 to state #Y may correspond to different distance zones between the UE and the network node. In particular, as shown in FIG. 4C, state #0 may correspond to a location relatively far from the network node but still within coverage (e.g., cell edge), while higher-numbered states (e.g., state #1 to state #Y) may represent progressively closer locations as the UE approaches the network node. Accordingly, the state index may increase with improved signal quality, which typically correlates with reduced distance between the UE and the network node.

In some cases, when the UE operates in the stage of normal RRM (i.e., the MR is ON and the LR is OFF), the UE may determine the network condition, including a measured signal quality, based on a signal transmitted from the network node. Then, the UE may determine a state #n of state #1 to state #Y based on the network condition. The UE may determine: (1) whether to activate the LR for LP-WUS monitoring and enable the MR with the stage of n^{th} RRM relaxation based on the network condition, or (2) whether to activate the LR for LP-WUS monitoring and idle the MR with the stage of offloading RRM to the LR based on the network condition.

In some cases, when the measured signal quality is greater than a threshold Thr #n (but not greater than a threshold Thr #n+1), the UE may determine state #n. Then, the UE may control (1) the LR to be activated for LP-WUS monitoring and the MR to be enabled with the stage of n^{th} RRM relaxation while n is between 1 to (Y−1), or (2) the LR to be activated for LP-WUS monitoring and the MR to be enabled with the stage of offloading RRM to the LR while n is Y.

In some cases, when the measured signal quality is not greater than a threshold Thr #1, the UE may determine state #0. Then, the UE may control the LR to be deactivated and the MR to be enabled with the stage of normal RRM. In some cases, when the UE receives an LP-WUS, the UE may determine state #0. Then, the UE may control the LR to be deactivated and the MR to be enabled with the stage of normal RRM.

More specifically, when the measured signal quality is greater than Thr #Y, the LR is activated, the MR is deactivated, and RRM is fully offloaded to the LR. The UE may remain in the current state (i.e., state #Y) unless an event occurs that causes the UE to transition back to state #0 or to another state. Such an event may include, for example, the LR receiving an LP-WUS, which may trigger activation of the MR and cause the UE to operate in a stage of normal RRM corresponding to state #0. It should be noted that state #Y may indicate that the channel condition may be sufficiently favorable such that the UE may rely solely on the LR while the MR remains deactivated.

In some cases, when the measured signal quality is between Thr #n and Thr #(n+1) while n is 1 to (Y−1), the LR is activated, and the MR is enabled with a stage of n^{th} RRM relaxation. The UE may remain in the current state (i.e., state #n) unless an event occurs that causes the UE to transition back to state #0 or to another state. Such an event may include, for example, the LR receiving an LP-WUS, which may trigger activation of the MR and cause the UE to operate in a stage of normal RRM corresponding to state #0. It should be noted that state #n may indicate that the channel condition may be sufficiently good such that the UE may rely on the LR while the MR operates in the n^{th} stage of RRM relaxation. It should be noted that the previous steps may be repeated for different thresholds (e.g., Thr #1 to Thr #Y) if multiple states exist between state #0 and State #Y, each corresponding to a different stage of RRM relaxation.

In some cases, when the measured signal quality is not greater than Thr #1, the LR is deactivated, and the MR is enabled with the stage of normal RRM. The UE may remain in the current state (i.e., state #0) unless an event occurs that causes the UE to transit to another state.

For example, there are a stage #0 of normal RRM, a stages #1 of RRM relaxation associated with a threshold Thr #1, a stages #2 of RRM relaxation associated with a threshold Thr #2, and a stage #3 of offloading RRM to LR associated with a threshold Thr #3. First, the UE is in state #0 corresponding to the stage of normal RRM.

When the UE determines that a measured signal quality is between Thr #1 and Thr #2, the MR of the UE enables 1^{st} stage of RRM relaxation (e.g., the RRM activity is reduced to a frequency between one-eighth and one-sixteenth of the normal operation), and the LR of the UE monitors LP-WUS in state #1.

When the UE determines that a measured signal quality is between Thr #2 and Thr #3, the MR of the UE enables 2^{nd} stage of RRM relaxation (e.g., the RRM activity may be reduced to less than one-sixteenth of the normal frequency), and the LR of the UE monitors LP-WUS in state #2.

When the UE determines that a measured signal quality is greater than Thr #3, the MR of UE is idled, and RRM is fully offloaded to LR at state #3.

It should be noted that, in this example, the UE may not be required to transition through state #1 to state #3 sequentially. The UE may transit to any of state #1 to state #3 directly when the measured signal quality satisfies the condition associated with the corresponding state. In other words, the UE may transit to any of state #1 to state #3 directly based on comparing the measured signal quality with the thresholds. Additionally, the UE may transit to state #0 when the LR receives an LP-WUS) or when the measured signal quality is not greater than the threshold Thr #1.

### Illustrative Implementations

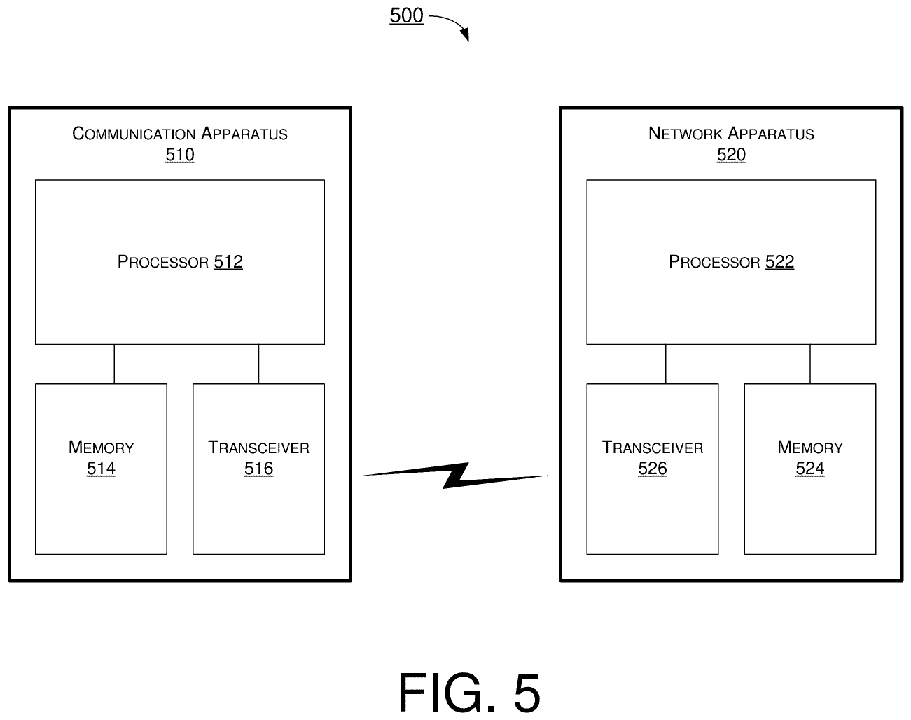

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to RRM relaxation and offloading with respect to UE and network apparatus in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including RRM relaxation and offloading in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In other words, processor 512 may transceive the data such as configuration, message, signal, information, indicator, etc. via transceiver 516. Transceiver 516 may include an MR and an LR. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In other words, processor 522 may transceive the data such as configuration, message, signal, information, indicator, etc. via transceiver 526. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

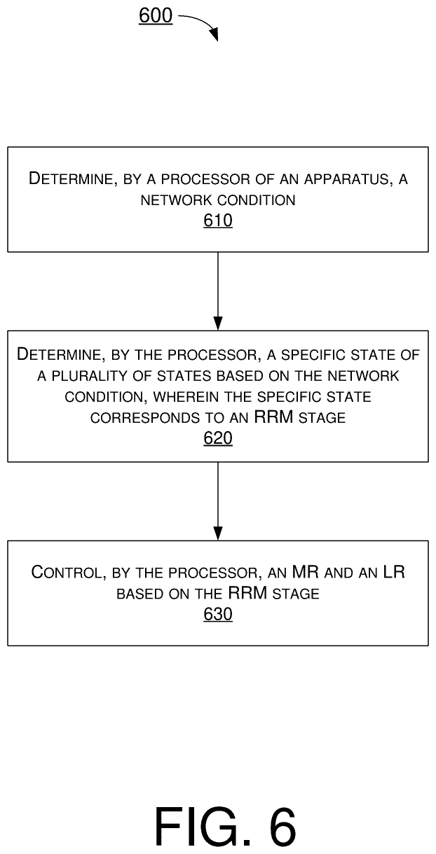

FIG. 6 illustrates an example process 600 in accordance with an implementation of the present disclosure. Process 600 may be an example implementation of above scenarios/schemes, whether partially or completely, with respect to RRM relaxation and offloading of the present disclosure. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 determining a network condition. Process 600 may proceed from block 610 to block 620.

At block 620, process 600 may involve processor 512 of communication apparatus 510 determining a specific state of a plurality of states based on the network condition. The specific state may correspond to an RRM stage. Process 600 may proceed from block 620 to block 630.

At block 630, process 600 may involve processor 512 of communication apparatus 510 controlling an MR and an LR based on the RRM stage.

In some implementations, the network condition may include a measured signal quality. Process 600 may involve processor 512 of communication apparatus 510 determining the specific state of the plurality of states in an event that the measured signal quality is greater than a threshold. The specific state may correspond to the RRM stage which includes a stage of RRM relaxation or a stage of offloading RRM to the LR. Process 600 may involve processor 512 of communication apparatus 510 enabling the MR with the stage of RRM relaxation and activating the LR for LP-WUS monitoring in an event that the RRM stage includes the stage of RRM relaxation, or idling the MR with the stage of offloading RRM to the LR and activating the LR for LP-WUS monitoring in an event that the RRM stage includes the stage of offloading RRM to the LR.

In some implementations, process 600 may involve processor 512 of communication apparatus 510 starting a timer. Process 600 may involve processor 512 of communication apparatus 510 determining another measured signal quality after the timer expires. Process 600 may involve processor 512 of communication apparatus 510 determining another specific state of the plurality of states in an event that the another measured signal quality is greater than the threshold.

In some implementations, the network condition may include a measured signal quality or a reception of LP-WUS. Process 600 may involve processor 512 of communication apparatus 510 determining the specific state of the plurality of states in an event that the measured signal quality is not greater than a threshold or based on the reception of LP-WU. The specific state may correspond to the RRM stage which includes a stage of normal RRM. Process 600 may involve processor 512 of communication apparatus 510 enabling the MR with the stage of normal RRM and deactivating the LR in an event that the RRM stage includes the stage of normal RRM.

In some implementations, the network condition may include a measured signal quality. Process 600 may involve processor 512 of communication apparatus 510 determining the specific state of the plurality of states in an event that the measured signal quality is greater than a threshold and a change associated with the measured signal quality is within a margin for a duration. The specific state may correspond to the RRM stage which includes a stage of RRM relaxation or a stage of offloading RRM to the LR. Process 600 may involve processor 512 of communication apparatus 510 enabling the MR with the stage of RRM relaxation and activating the LR for LP-WUS monitoring in an event that the RRM stage includes the stage of RRM relaxation, or idling the MR with the stage of offloading RRM to the LR and activating the LR for LP-WUS monitoring in an event that the RRM stage includes the stage of offloading RRM to the LR.

In some implementations, a reference value used to determine the change associated with the measured signal quality may include a baseline signal quality or a previously measured signal quality.

In some implementations, the network condition may include a measured signal quality or a reception of LP-WUS. Process 600 may involve processor 512 of communication apparatus 510 determining the specific state of the plurality of states in an event that the measured signal quality is not greater than a threshold after determining a change associated with the measured signal quality is over a margin or based on the reception of LP-WUS. The specific state may correspond to the RRM stage which includes a stage of normal RRM. Process 600 may involve processor 512 of communication apparatus 510 enabling the MR with the stage of normal RRM and deactivating the LR in an event that the RRM stage includes the stage of normal RRM.

In some implementations, the network condition may include a measured signal quality. Process 600 may involve processor 512 of communication apparatus 510 determining the specific state of the plurality of states in an event that the measured signal quality is greater than a threshold associated with the specific state. The specific state may correspond to the RRM stage which includes a stage of RRM relaxation or a stage of offloading RRM to the LR. Process 600 may involve processor 512 of communication apparatus 510 enabling the MR with the stage of RRM relaxation and activating the LR for Low Power Wake Up signal (LP-WUS) monitoring in an event that the RRM stage includes the stage of RRM relaxation, or idling the MR with the stage of offloading RRM to the LR and activating the LR for LP-WUS monitoring in an event that the RRM stage includes the stage of offloading RRM to the LR. The threshold associated with the specific state may have a first value in an event that the specific state corresponds to the RRM stage including the stage of RRM relaxation. The threshold associated with the specific state may have a second value in an event that the specific state corresponds to the RRM stage including the stage of offloading RRM to the LR. The second value may be greater than the first value.

In some implementations, the network condition may include a measured signal quality or a reception of LP-WUS. Process 600 may involve processor 512 of communication apparatus 510 determining the specific state of the plurality of states in an event that the measured signal quality is not greater than a threshold associated with a higher state or based on the reception of LP-WUS. The specific state may correspond to the RRM stage which includes a stage of normal RRM. Process 600 may involve processor 512 of communication apparatus 510 enabling the MR with the stage of normal RRM and deactivating the LR in an event that the RRM stage includes the stage of normal RRM.

In some implementations, the network condition may include a measured signal quality. Process 600 may involve processor 512 of communication apparatus 510 determining the specific state of the plurality of states in an event that the measured signal quality is not greater than a threshold associated with a higher state. The specific state may correspond to the RRM stage which includes a stage of RRM relaxation. Process 600 may involve processor 512 of communication apparatus 510 enabling the MR with the stage of RRM relaxation and activating the LR for LP-WUS monitoring in an event that the RRM stage includes the stage of RRM relaxation.

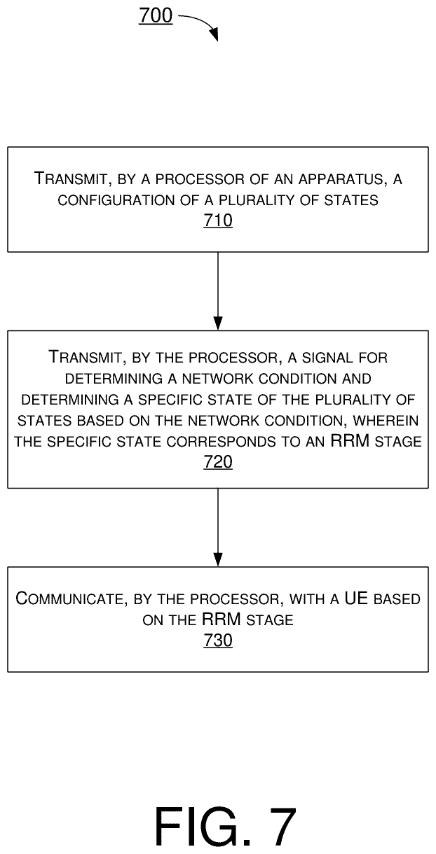

FIG. 7 illustrates an example process 700 in accordance with an implementation of the present disclosure. Process 700 may be an example implementation of above scenarios/schemes, whether partially or completely, with respect to RRM relaxation and offloading of the present disclosure. Process 700 may represent an aspect of implementation of features of network apparatus 520. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any suitable network device or machine type devices. Solely for illustrative purposes and without limitation, process 700 is described below in the context of network apparatus 520. Process 700 may begin at block 710.

At block 710, process 700 may involve processor 522 of network apparatus 520 transmitting a configuration of a plurality of states. Process 700 may proceed from block 710 to block 720.

At block 720, process 700 may involve processor 522 of network apparatus 520 transmitting a signal for determining a network condition and determining a specific state of the plurality of states based on the network condition. The specific state may correspond to an RRM stage. Process 700 may proceed from block 720 to block 730.

At block 730, process 700 may involve processor 522 of network apparatus 520 communicating with a UE based on the RRM stage.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more; ” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc. ” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc. ” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a network condition;
determining, by the processor, a specific state of a plurality of states based on the network condition, wherein the specific state corresponds to a Radio Resource Management (RRM) stage; and
controlling, by the processor, a Main Radio (MR) and a Low-power Receiver (LR) based on the RRM stage.

2. The method of claim 1, wherein the network condition includes a measured signal quality, and the step of determining the specific state of the plurality of states based on the network condition further includes:
determining the specific state of the plurality of states in an event that the measured signal quality is greater than a threshold, wherein the specific state corresponds to the RRM stage which includes a stage of RRM relaxation or a stage of offloading RRM to the LR,
wherein the step of controlling the MR and the LR based on the RRM stage further includes:
enabling the MR with the stage of RRM relaxation and activating the LR for Low Power Wake Up signal (LP-WUS) monitoring in an event that the RRM stage includes the stage of RRM relaxation, or
idling the MR with the stage of offloading RRM to the LR and activating the LR for LP-WUS monitoring in an event that the RRM stage includes the stage of offloading RRM to the LR.

3. The method of claim 2, wherein the RRM stage includes the stage of RRM relaxation, and the method further comprises:
starting, by the processor, a timer;
determining, by the processor, another measured signal quality after the timer expires; and
determining, by the processor, another specific state of the plurality of states in an event that the another measured signal quality is greater than the threshold.

4. The method of claim 1, wherein the network condition includes a measured signal quality or a reception of Low Power Wake Up signal (LP-WUS), and the step of determining the specific state of the plurality of states based on the network condition further includes:
determining the specific state of the plurality of states in an event that the measured signal quality is not greater than a threshold or based on the reception of LP-WUS, wherein the specific state corresponds to the RRM stage which includes a stage of normal RRM,
wherein the step of controlling the MR and the LR based on the RRM stage further includes:
enabling the MR with the stage of normal RRM and deactivating the LR in an event that the RRM stage includes the stage of normal RRM.

5. The method of claim 1, wherein the network condition includes a measured signal quality, and the step of determining the specific state of the plurality of states based on the network condition further includes:
determining the specific state of the plurality of states in an event that the measured signal quality is greater than a threshold and a change associated with the measured signal quality is within a margin for a duration, wherein the specific state corresponds to the RRM stage which includes a stage of RRM relaxation or a stage of offloading RRM to the LR,
wherein the step of controlling the MR and the LR based on the RRM stage further includes:
enabling the MR with the stage of RRM relaxation and activating the LR for Low Power Wake Up signal (LP-WUS) monitoring in an event that the RRM stage includes the stage of RRM relaxation, or
idling the MR with the stage of offloading RRM to the LR and activating the LR for LP-WUS monitoring in an event that the RRM stage includes the stage of offloading RRM to the LR.

6. The method of claim 5, wherein a reference value used to determine the change associated with the measured signal quality includes a baseline signal quality or a previously measured signal quality.

7. The method of claim 1, wherein the network condition includes a measured signal quality or a reception of Low Power Wake Up signal (LP-WUS), and the step of determining the specific state of the plurality of states based on the network condition further includes:
determining the specific state of the plurality of states in an event that the measured signal quality is not greater than a threshold after determining a change associated with the measured signal quality is over a margin, or based on the reception of LP-WUS, wherein the specific state corresponds to the RRM stage which includes a stage of normal RRM,
wherein the step of controlling the MR and the LR based on the RRM stage further includes:
enabling the MR with the stage of normal RRM and deactivating the LR in an event that the RRM stage includes the stage of normal RRM.

8. The method of claim 1, wherein the network condition includes a measured signal quality, and the step of determining the specific state of the plurality of states based on the network condition further includes:
determining the specific state of the plurality of states in an event that the measured signal quality is greater than a threshold associated with the specific state, wherein the specific state corresponds to the RRM stage which includes a stage of RRM relaxation or a stage of offloading RRM to the LR,
wherein the step of controlling the MR and the LR based on the RRM stage further includes:
enabling the MR with the stage of RRM relaxation and activating the LR for Low Power Wake Up signal (LP-WUS) monitoring in an event that the RRM stage includes the stage of RRM relaxation, or
idling the MR with the stage of offloading RRM to the LR and activating the LR for LP-WUS monitoring in an event that the RRM stage includes the stage of offloading RRM to the LR,
wherein the threshold associated with the specific state has a first value in an event that the specific state corresponds to the RRM stage including the stage of RRM relaxation, the threshold associated with the specific state has a second value in an event that the specific state corresponds to the RRM stage including the stage of offloading RRM to the LR, and the second value is greater than the first value.

9. The method of claim 1, wherein the network condition includes a measured signal quality or a reception of Low Power Wake Up signal (LP-WUS), and the step of determining the specific state of the plurality of states based on the network condition further includes:
determining the specific state of the plurality of states in an event that the measured signal quality is not greater than a threshold associated with a higher state or based on the reception of LP-WUS, wherein the specific state corresponds to the RRM stage which includes a stage of normal RRM,
wherein the step of controlling the MR and the LR based on the RRM stage further includes:
enabling the MR with the stage of normal RRM and deactivating the LR in an event that the RRM stage includes the stage of normal RRM.

10. The method of claim 1, wherein the network condition includes a measured signal quality, and the step of determining the specific state of the plurality of states based on the network condition further includes:
determining the specific state of the plurality of states in an event that the measured signal quality is not greater than a threshold associated with a higher state, wherein the specific state corresponds to the RRM stage which includes a stage of RRM relaxation,
wherein the step of controlling the MR and the LR based on the RRM stage further includes:
enabling the MR with the stage of RRM relaxation and activating the LR for Low Power Wake Up signal (LP-WUS) monitoring in an event that the RRM stage includes the stage of RRM relaxation.

11. An apparatus, comprising:
a transceiver which, during operation, wirelessly communicates with a wireless network; and
a processor communicatively coupled to the transceiver such that, during operation, the processor performs operations comprising:
determining a network condition;
determining a specific state of a plurality of states based on the network condition, wherein the specific state corresponds to a Radio Resource Management (RRM) stage; and
controlling a Main Radio (MR) and a Low-power Receiver (LR) based on the RRM stage.

12. The apparatus of claim 11, wherein the network condition includes a measured signal quality, and the processor further performs operations comprising:
determining the specific state of the plurality of states in an event that the measured signal quality is greater than a threshold, wherein the specific state corresponds to the RRM stage which includes a stage of RRM relaxation or a stage of offloading RRM to the LR,
wherein the processor further performs operations comprising:
enabling the MR with the stage of RRM relaxation and activating the LR for Low Power Wake Up signal (LP-WUS) monitoring in an event that the RRM stage includes the stage of RRM relaxation, or
idling the MR with the stage of offloading RRM to the LR and activating the LR for LP-WUS monitoring in an event that the RRM stage includes the stage of offloading RRM to the LR.

13. The apparatus of claim 12, wherein the RRM stage includes the stage of RRM relaxation, and the processor further performs operations comprising:
starting a timer;
determining another measured signal quality after the timer expires; and
determining another specific state of the plurality of states in an event that the another measured signal quality is greater than the threshold.

14. The apparatus of claim 11, wherein the network condition includes a measured signal quality or a reception of Low Power Wake Up signal (LP-WUS), and the processor further performs operations comprising:
determining the specific state of the plurality of states in an event that the measured signal quality is not greater than a threshold or based on the reception of LP-WUS, wherein the specific state corresponds to the RRM stage which includes a stage of normal RRM,
wherein the processor further performs operations comprising:
enabling the MR with the stage of normal RRM and deactivating the LR in an event that the RRM stage includes the stage of normal RRM.

15. The apparatus of claim 11, wherein the network condition includes a measured signal quality, and the processor further performs operations comprising:
determining the specific state of the plurality of states in an event that the measured signal quality is greater than a threshold and a change associated with the measured signal quality is within a margin for a duration, wherein the specific state corresponds to the RRM stage which includes a stage of RRM relaxation or a stage of offloading RRM to the LR,
wherein the processor further performs operations comprising:
enabling the MR with the stage of RRM relaxation and activating the LR for Low Power Wake Up signal (LP-WUS) monitoring in an event that the RRM stage includes the stage of RRM relaxation, or
idling the MR with the stage of offloading RRM to the LR and activating the LR for LP-WUS monitoring in an event that the RRM stage includes the stage of offloading RRM to the LR.

16. The apparatus of claim 11, wherein the network condition includes a measured signal quality or a reception of Low Power Wake Up signal (LP-WUS), and the processor further performs operations comprising:
determining the specific state of the plurality of states in an event that the measured signal quality is not greater than a threshold after determining a change associated with the measured signal quality is over a margin, or based on the reception of LP-WUS, wherein the specific state corresponds to the RRM stage which includes a stage of normal RRM,
wherein the processor further performs operations comprising:
enabling the MR with the stage of normal RRM and deactivating the LR in an event that the RRM stage includes the stage of normal RRM.

17. The apparatus of claim 11, wherein the network condition includes a measured signal quality, and the processor further performs operations comprising:
determining the specific state of the plurality of states in an event that the measured signal quality is greater than a threshold associated with the specific state, wherein the specific state corresponds to the RRM stage which includes a stage of RRM relaxation or a stage of offloading RRM to the LR,
wherein the processor further performs operations comprising:
enabling the MR with the stage of RRM relaxation and activating the LR for Low Power Wake Up signal (LP-WUS) monitoring in an event that the RRM stage includes the stage of RRM relaxation, or
idling the MR with the stage of offloading RRM to the LR and activating the LR for LP-WUS monitoring in an event that the RRM stage includes the stage of offloading RRM to the LR,
wherein the threshold associated with the specific state has a first value in an event that the specific state corresponds to the RRM stage including the stage of RRM relaxation, the threshold associated with the specific state has a second value in an event that the specific state corresponds to the RRM stage including the stage of offloading RRM to the LR, and the second value is greater than the first value.

18. The apparatus of claim 11, wherein the network condition includes a measured signal quality or a reception of Low Power Wake Up signal (LP-WUS), and the processor further performs operations comprising:
determining the specific state of the plurality of states in an event that the measured signal quality is not greater than a threshold associated with a higher state or based on the reception of LP-WUS, wherein the specific state corresponds to the RRM stage which includes a stage of normal RRM,
wherein the processor further performs operations comprising:
enabling the MR with the stage of normal RRM and deactivating the LR in an event that the RRM stage includes the stage of normal RRM.

19. The apparatus of claim 11, wherein the network condition includes a measured signal quality, and the processor further performs operations comprising:
determining the specific state of the plurality of states in an event that the measured signal quality is not greater than a threshold associated with a higher state, wherein the specific state corresponds to the RRM stage which includes a stage of RRM relaxation,
wherein the processor further performs operations comprising:
enabling the MR with the stage of RRM relaxation and activating the LR for Low Power Wake Up signal (LP-WUS) monitoring in an event that the RRM stage includes the stage of RRM relaxation.

20. A method, comprising:
transmitting, by a processor of an apparatus, a configuration of a plurality of states;
transmitting, by the processor, a signal for determining a network condition and determining a specific state of the plurality of states based on the network condition, wherein the specific state corresponds to a Radio Resource Management (RRM) stage; and
communicating, by the processor, with a User Equipment (UE) based on the RRM stage.
